(19) United States
(12) Patent Application Publication
(10) Pub. No.: US 2024/0296533 A1
(43) Pub. Date: Sep. 5, 2024

(54) IMAGE PROCESSING APPARATUS, IMAGE PICKUP APPARATUS, IMAGE PROCESSING METHOD, AND STORAGE MEDIUM

(71) Applicant: CANON KABUSHIKI KAISHA, Tokyo (JP)

(72) Inventor: MINAKO KAMIYAMA, Tokyo (JP)

(21) Appl. No.: 18/582,063

(22) Filed: Feb. 20, 2024

(30) Foreign Application Priority Data
Mar. 1, 2023 (JP) 2023-031394

(51) Int. Cl. G06T 5/80; G06T 5/50

(52) U.S. Cl. CPC G06T 5/80; G06T 5/50; G06T 2207/20224

(57) ABSTRACT

An image processing apparatus includes a memory storing instructions, and a processor configured to execute the instructions to acquire optical characteristic data of an optical system, acquire information about zoom magnification, acquire information about a distance to an object, acquire a change amount of at least one of the zoom magnification and the distance based on at least one of the information about the zoom magnification and the information about the distance, determine a characteristic to be applied to first image data based on the change amount and the optical characteristic data, and generate second image data by applying the characteristic to the first image data.

### BACKGROUND

### Technical Field

One of the aspects of the embodiments relates to an image processing apparatus, an image pickup apparatus, an image processing method, and a storage medium.

### Description of Related Art

Japanese Patent Laid-Open No. 2017-41791 discloses a method of determining whether to perform image processing such as skin beautification based on whether a human face exists in an image. This method exploits a characteristic that a human face exists in an image in imaging a portrait and performs image processing only for an image to be provided with a skin beautification effect, thereby reducing influence of the image processing.

Japanese Patent Laid-Open No. 11-353477 discloses an image processing method of reproducing flare by converting an original image signal into a converted image signal representing an amount corresponding to object luminance, incident light intensity, or regeneration luminance, performing smoothing processing for the converted image signal, and then inversely converting the converted image signal into an image signal.

With the method disclosed in Japanese Patent Laid-Open No. 2017-41791, an adverse effect is more noticeable than a skin beautification effect in a case where a face in an image is small, and specifically, an image blur is noticeable. With the image processing method disclosed in Japanese Patent Laid-Open No. 11-353477, an applied effect may be too strong or too weak in some cases, depending on the object size.

Furthermore, in a case where the object size in the angle of view changes during imaging, the calculation amount increases in an attempt to apply a proper characteristic while the object size in the angle of view is calculated.

### SUMMARY

An image processing apparatus according to one aspect of the disclosure includes a memory storing instructions, and a processor configured to execute the instructions to acquire optical characteristic data of an optical system, acquire information about zoom magnification, acquire information about a distance to an object, acquire a change amount of at least one of the zoom magnification and the distance based on at least one of the information about the zoom magnification and the information about the distance, determine a characteristic to be applied to first image data based on the change amount and the optical characteristic data, and generate second image data by applying the characteristic to the first image data. An image pickup apparatus having the above image processing apparatus also constitutes another aspect of the disclosure. An image processing method corresponding to the above image processing apparatus also constitutes another aspect of the disclosure. A storage medium storing a program that causes a computer to execute the above image processing method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram of an image pickup apparatus according to a first embodiment.

FIG. 2 is a flowchart illustrating processing by the image pickup apparatus according to the first embodiment.

FIG. 3 illustrates change patterns of the size of an object in the angle of view in the first embodiment.

FIG. 4 is a graph illustrating a relationship between an object size and zoom magnification in the first embodiment.

FIG. 5 is a graph illustrating a relationship between an object size and a distance between the image pickup apparatus according to the first embodiment and the object.

FIG. 6 is a graph illustrating a relationship between the object size and the distance between the image pickup apparatus according to the first embodiment and the object.

FIG. 7 is a diagram illustrating a point spread function (PSF) for applying a characteristic with a small blur amount in the first embodiment.

FIG. 8 is a diagram illustrating a PSF for applying a characteristic with a large blur amount in the first embodiment.

FIG. 9 is a block diagram of an image processing apparatus according to a second embodiment.

FIG. 10 is a flowchart illustrating processing by the image processing apparatus according to the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

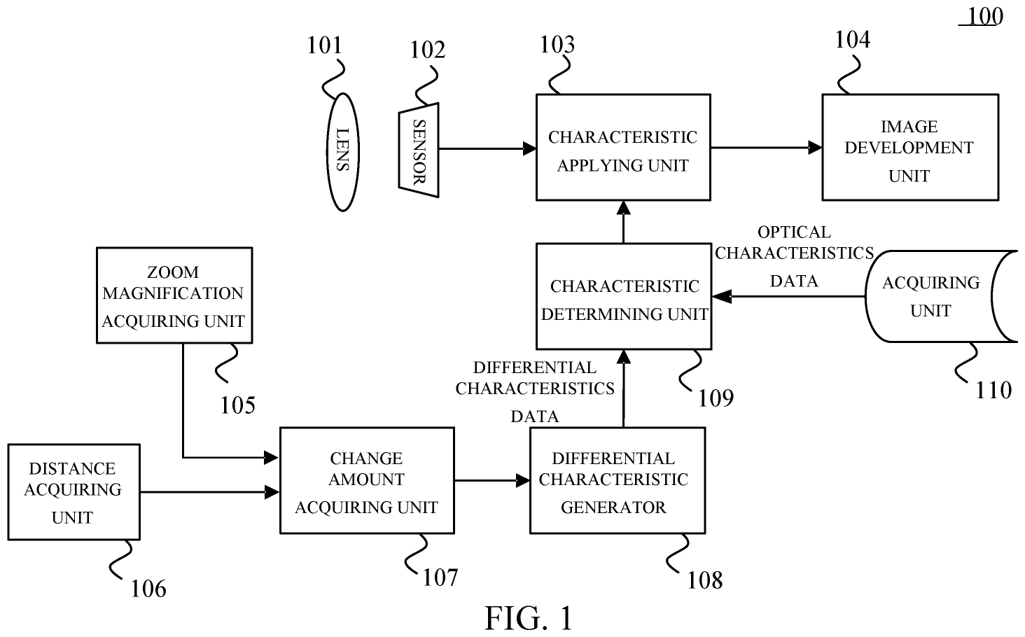

Referring now to FIG. 1, a description will be given of an image pickup apparatus (image processing apparatus) 100 in a first embodiment. FIG. 1 is a block diagram of the image pickup apparatus 100. A lens 101 is an optical system (image pickup optical system) that forms an optical image of an object. A sensor 102 is an image sensor such as a CMOS sensor and photoelectrically converts an optical image formed through the lens 101 and outputs raw image data. In this embodiment, a lens apparatus including the lens 101 is detachably attached to a camera body including the sensor 102, but this embodiment is not limited to this example and the camera body and the lens apparatus may be integrated.

A characteristic applying unit (first generator) 103 applies a lens characteristic to be described below to raw image data (first image data) through image processing, thereby generating raw image data (second image data) to which a desired lens characteristic is applied. Thus, the characteristic applying unit 103 performs image processing for raw image data by using a characteristic (applied characteristic) corresponding to a characteristic (for example, aberration characteristic) of the lens 101, thereby generating raw image data to which a lens characteristic is applied. An image development unit 104 develops such raw image data to which a lens characteristic is applied, and outputs video data. The video data is used for video recording and video outputting.

A zoom magnification acquiring unit (second acquiring unit) 105 acquires information about zoom magnification. The zoom magnification is zoom magnification for at least one of optical zoom control and electronic zoom control (digital zoom control). The information about the zoom magnification includes not only the value of the zoom magnification but also position information about a zoom lens, drive information about the zoom lens, and information about the focal length. A distance acquiring unit (third acquiring unit) 106 acquires a distance to the object, in other words, a distance between the image pickup apparatus 100 and the object (information about the distance). The distance can be acquired by using a sensor such as a laser sensor, an ultrasonic sensor, an infrared sensor, or a phase difference sensor, and the information about the distance includes not only the value of the distance but also information output from each sensor and yet to be converted into the distance. In a case where a plurality of objects exist in the angle of view, the distance acquiring unit 106 may acquire the distance to one object selected from among the plurality of objects. As a method of acquiring the distance to one object selected from among the plurality of objects, the distance to each of the plurality of objects may be acquired and then the distance to the one object may be selected. Alternatively, one object may be selected from among the plurality of objects and only the distance to the selected object may be acquired. One object may be automatically determined by the image pickup apparatus 100 or may be determined based on designation by a user.

The zoom magnification acquired by the zoom magnification acquiring unit 105 and the distance acquired by the distance acquiring unit 106 are output to a change amount acquiring unit (fourth acquiring unit) 107. The change amount acquiring unit 107 outputs, to a differential characteristic generator (second generator) 108, a change amount characteristic used to determine change in the size of an object in the angle of view. The change amount characteristic is determined for each frame.

The differential characteristic generator 108 generates, based on the change amount characteristic acquired by the change amount acquiring unit 107, differential characteristic (differential characteristic data) for changing an applied lens characteristic (aberration characteristic), and outputs the generated differential characteristic to a characteristic determining unit 109. The differential characteristic includes a difference between a characteristic (first characteristic) already applied and a characteristic (second characteristic) to be applied next. The differential characteristic is updated at a timing when the characteristic to be changed is changed. The characteristic determining unit 109 determines the characteristic to be applied next based on the differential characteristic and the characteristic already applied.

The characteristic determining unit 109 uses, as a characteristic at imaging start, a lens characteristic (optical characteristic data) acquired from an acquiring unit (first acquiring unit) 110. The lens characteristic (optical characteristic data) acquired from the acquiring unit 110 is, for example, a parameter for reproducing the aberration characteristic of the lens 101 by signal processing. The parameter only needs to allow reproduction of a characteristic identical or close to the aberration characteristic of the lens 101.

The characteristic determined by the characteristic determining unit 109 is output to the characteristic applying unit 103 and stored in the characteristic determining unit 109 to determine a further subsequent characteristic. The characteristic applying unit 103 applies the characteristic determined by the characteristic determining unit 109 to the image data output from the sensor 102, thereby obtaining image data to which a desired lens characteristic is applied.

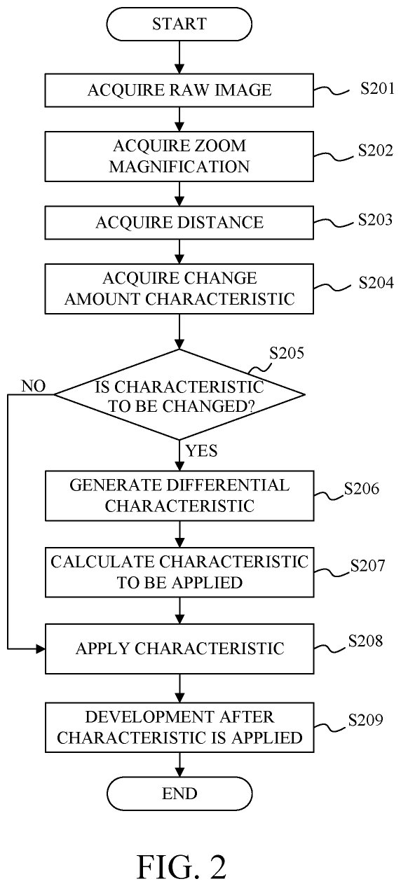

Referring now to FIG. 2, a description will be given of processing (image processing method) by the image pickup apparatus 100 according to this embodiment. FIG. 2 is a flowchart illustrating the processing by the image pickup apparatus 100.

First at step S201, the image pickup apparatus 100 acquires raw image (first image data) obtained by imaging at the sensor 102. Next, at step S202, the zoom magnification acquiring unit 105 acquires the zoom magnification in a case where imaging is performed at step S201. Next, at step S203, the distance acquiring unit 106 acquires the distance between the image pickup apparatus 100 and the object in a case where imaging is performed at step S201. Next, at step S204, the change amount acquiring unit 107 calculates (acquires) a change amount characteristic through calculation to be described below by using the zoom magnification and the distance acquired at steps S202 and S203, respectively.

Next, at step S205, the change amount acquiring unit 107 determines whether to change a characteristic to be applied based on the change amount characteristic acquired at step S204. The change amount acquiring unit 107 determines whether to change the characteristic in accordance with, for example, whether the change amount (change amount characteristic) of the object size, which is determined based on the relationship between the change amount of the zoom magnification and the change amount of the distance falls within a predetermined range. The predetermined range is not limited to a case where the change amount of the object size is zero, but may be a change amount range in which it is determined that the object size does not change in effect. In a case where it is determined at step S205 that the characteristic is to be changed, the flow proceeds to step S206. In a case where it is determined that the characteristic is not to be changed, the flow proceeds to step S208. In other words, the characteristic determining unit 109 does not change the characteristic in a case where it is determined that the change amount of the object size, which is determined based on the relationship between the change amount of the zoom magnification and the change amount of the distance falls within the predetermined range.

At step S206, the differential characteristic generator 108 generates a differential characteristic (differential characteristic data). Next, at step S207, the characteristic determining unit 109 calculates a characteristic (applied characteristic) to be applied to raw image data based on the differential characteristic generated at step S206 and a lens characteristic (optical characteristic data) acquired from the acquiring unit 110. Next, at step S208, the characteristic applying unit 103 applies the characteristic to the raw image data (first image data), thereby generating raw image data (second image data) to which the characteristic is applied. Finally, at step S209, the image development unit 104 develops the raw image data to which the characteristic is applied, thereby generating an image signal to be used for recording or outputting.

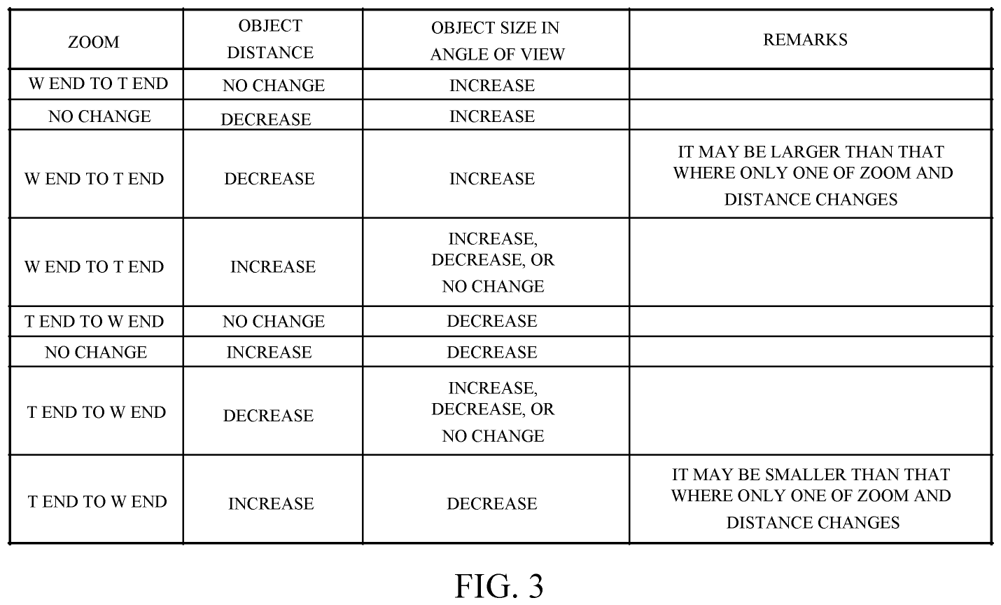

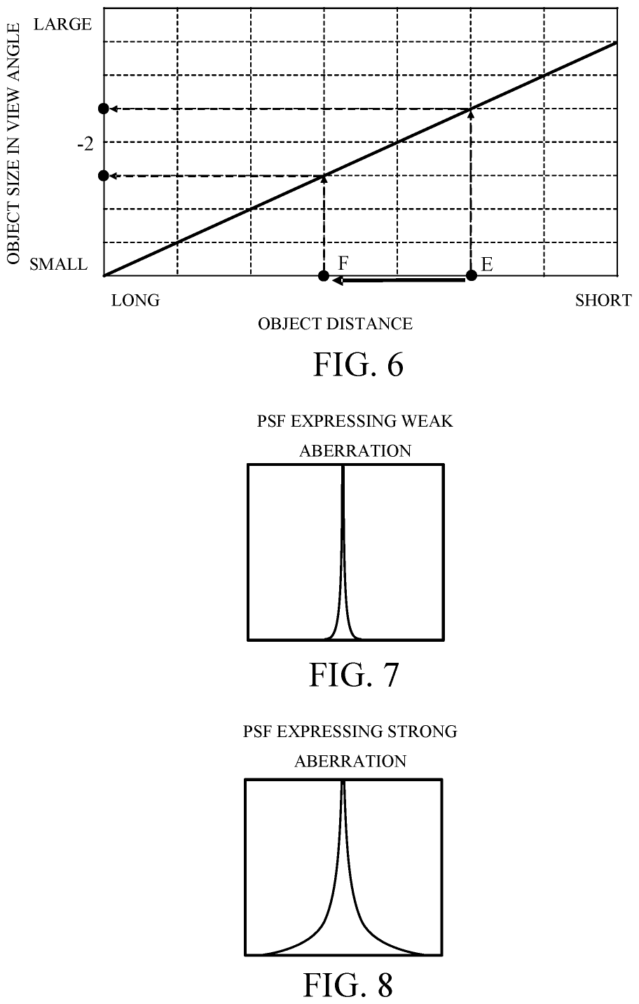

Referring now to FIGS. 3 and 6, a description will be given of the method of determining a change amount characteristic acquired by the change amount acquiring unit 107. FIG. 3 illustrates change patterns of the object size in the angle of view. FIG. 3 illustrates eight patterns as the change patterns. The change amount characteristic is determined based on change in the object size in the angle of view in accordance with change in the object size in the angle of view and change in the distance between the image pickup apparatus 100 and the object when the zoom magnification is changed.

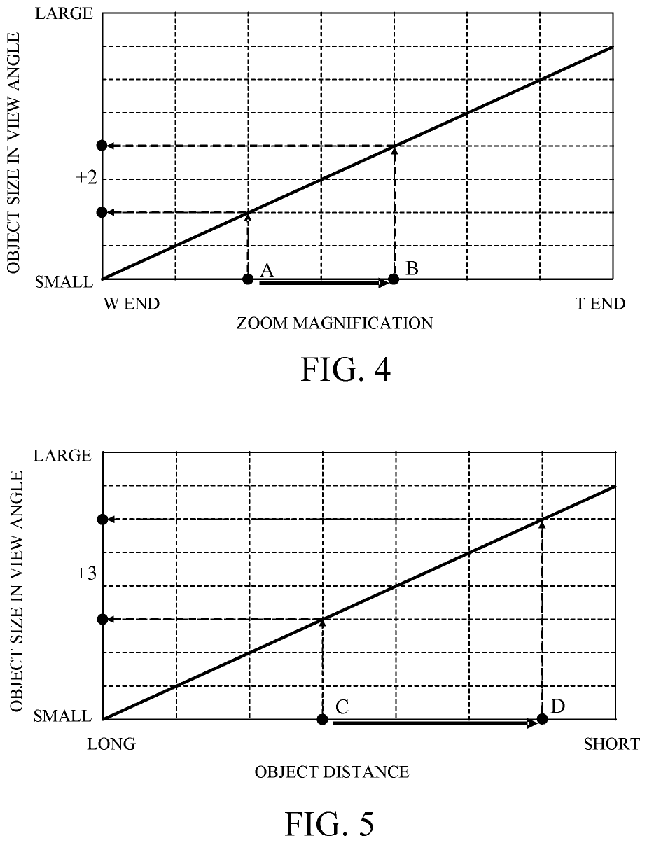

FIG. 4 is a graph illustrating a relationship between the object size in the angle of view and the zoom magnification. In FIG. 4, the horizontal axis represents the zoom magnification, and the vertical axis represents the object size in the angle of view. FIG. 5 is a graph illustrating a relationship between the object size in the angle of view and the distance between the image pickup apparatus 100 and the object. In FIG. 5, the horizontal axis represents the distance between the image pickup apparatus 100 and the object, and the vertical axis represents the object size in the angle of view. FIG. 6 is a graph illustrating a relationship between the object size in the angle of view and the distance between the image pickup apparatus 100 and the object and corresponds to a situation different from that of FIG. 5. In FIG. 6, the horizontal axis represents the distance between the image pickup apparatus 100 and the object, and the vertical axis represents the object size in the angle of view.

Referring now to FIGS. 4 and 5, a description will be given of the change amount characteristic in a case where the zoom magnification is changed from a wide-angle end (W end) to a telephoto end (T end) and the distance between the image pickup apparatus 100 and the object becomes shorter. As illustrated in FIG. 4, the change amount characteristic is “+2” when the zoom magnification is changed from “A” to “B” at a certain time interval. As illustrated in FIG. 5, the change amount characteristic is “+3” when the distance between the image pickup apparatus 100 and the object is changed from “C” to “D” at a certain time interval. As a result, the sum of the change amount characteristic related to the zoom magnification and the change amount characteristic related to the distance between the image pickup apparatus 100 and the object is (+2)+ (+3)=5. In this case, a characteristic applied by the characteristic applying unit 103 is changed.

Referring now to FIGS. 4 and 6, a description will be given of the change amount characteristic in a case where the zoom magnification is changed from the wide-angle end (Wide end) to the telephoto end (Tele end) and the distance between the image pickup apparatus 100 and the object becomes longer. As described above with reference to FIG. 4, the change amount characteristic is “+2” the zoom magnification is changed from “A” to “B” at a certain time interval. As illustrated in FIG. 6, the change amount characteristic is “−2” when the distance between the image pickup apparatus 100 and the object is changed from “E” to “F” at a certain time interval. As a result, the sum of the change amount characteristic related to the zoom magnification the and change amount characteristic related to the distance between the image pickup apparatus 100 and the object is (+2)+ (−2)=0. In other words, a change in the object size due to a change in the zoom magnification and a change in the object size due to a change in the distance between the image pickup apparatus 100 and the object are opposite to each other and the change amounts thereof are equal to each other. In this case, a characteristic applied by the characteristic applying unit 103 is not changed.

A description will now be given of a characteristic (characteristic of the lens 101) applied by the characteristic applying unit 103. The characteristic applied by the characteristic applying unit 103 is a point spread function (PSF). FIG. 7 illustrates a PSF that applies a characteristic with a small blur amount (aberration) (PSF that expresses weak aberration). FIG. 8 illustrates a PSF that applies a characteristic with a large blur amount (aberration) (PSF that expresses strong aberration). From FIGS. 7 and 8, the PSF that provides the characteristic with the large blur amount has a more widely spreading shape. This indicates that values positioned on the outer side in a matrix for applying a characteristic are larger for the characteristic with the large blur amount than for the characteristic with the small blur amount.

Thus, in the change amount characteristic illustrated in FIGS. 4 and 5, since the object size in the angle of view increases, a filter generated by the differential characteristic generator 108 has a differential characteristic for changing the values of a filter of an already applied characteristic so that values on the outer side increase.

The characteristic determining unit 109 determines a characteristic to be applied in the next frame based on the already applied characteristic and the differential characteristic generated by the differential characteristic generator 108. In this embodiment, the number of taps with which the characteristic applying unit 103 performs convolution calculation is nine. The convolution calculation in this case is calculation with a 9×9 matrix centered at a focus pixel as setting. Thus, the already applied characteristic and the differential characteristic are each a 9×9 matrix. The matrix of the already applied characteristic is represented by M, and the matrix of the differential characteristic is represented by M_D. The matrices M (i, j) and M_D (i, j) of these two characteristics are changed by using the four basic calculation operations.

A reason why the differential characteristic is generated will be described. This embodiment assumes that the image pickup apparatus 100 acquires information about the lens 101 from the lens 101, calculates the size of an object imaged on the sensor 102 based on the acquired information, and applies a characteristic in accordance with the object size by the characteristic applying unit 103. In such an image pickup apparatus, the object size is calculated and a characteristic to be applied is determined each time the object size changes. As a result, the calculation amount is large and it is difficult to smoothly perform characteristic application in imaging an image (video). Thus, in this embodiment, the change amount acquiring unit 107 determines change in the object size in the angle of view based on the change amount characteristic, and the differential characteristic generator 108 generates a differential characteristic and changes an already applied characteristic.

In this embodiment, the characteristic determining unit 109 determines a characteristic so that aberration becomes stronger in a case where it is determined that the object changes to become larger, and determines the characteristic so that aberration becomes weaker in a case where it is determined based on a change amount that the object changes to become smaller.

In this embodiment, the characteristic determining unit 109 determines the characteristic as a third characteristic so that aberration becomes stronger in any one of a case where a change has occurred by a first change amount so that the zoom magnification becomes larger and a case where a change has occurred by a second change amount so that the distance becomes shorter. The characteristic determining unit 109 determines a fourth characteristic so that aberration becomes stronger than with the third characteristic in a case where the zoom magnification has changed by the first change amount and the distance has changed by the second change amount.

In this embodiment, the characteristic determining unit 109 determines the characteristic to be a fifth characteristic so that aberration becomes weaker in any one of a case where a change has occurred by a third change amount so that the zoom magnification becomes smaller and a case where a change has occurred by a fourth change amount so that the distance becomes longer. The characteristic determining unit 109 determines a sixth characteristic so that aberration becomes weaker than with the fifth characteristic in a case where the zoom magnification has changed by the third change amount and the distance has changed by the fourth change amount.

In this embodiment, the characteristic determining unit 109 does not change the characteristic in a case where it is determined that the change amount of the object size, which is determined based on the relationship between the change amount of the zoom magnification and the change amount of the distance falls within the predetermined range.

This embodiment can reduce the calculation amount and smoothly change a characteristic applied to captured image data. This embodiment assumes that the lens 101 is an interchangeable lens, and a characteristic applied to an image is affected by both the mounted lens 101 and the applied characteristic. To reduce influence of the mounted lens 101, a characteristic corrected in accordance with a characteristic of the mounted lens may be stored as a characteristic acquired from the acquiring unit 110.

### Second Embodiment

A second embodiment will now be described. In this embodiment, an image processing apparatus obtains an image from imaging raw data.

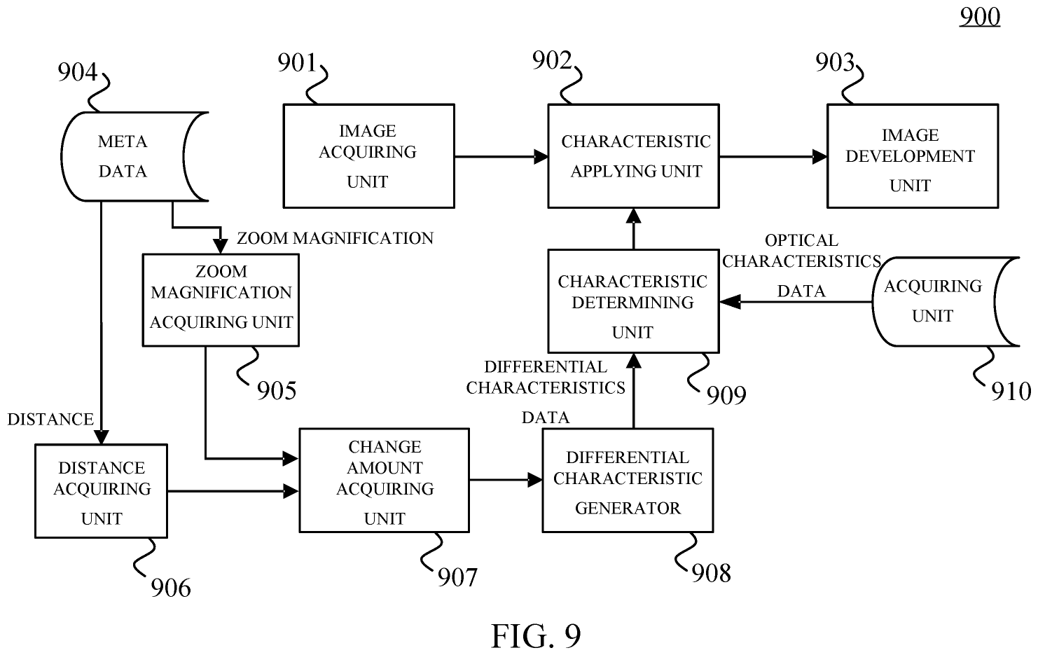

Referring now to FIG. 9, a description will be given of an image processing apparatus 900 according to this embodiment. FIG. 9 is a block diagram of the image processing apparatus 900. An image acquiring unit 901 acquires a captured image (first image data) and inputs the image to the image processing apparatus 900. A zoom magnification acquiring unit (second acquiring unit) 905 and a distance acquiring unit (third acquiring unit) 906 acquire, from metadata 904 of the image that is input through the image acquiring unit 901, zoom magnification (focal length) and the distance between an image pickup apparatus and an object, respectively. The data (the zoom magnification and the information about the distance) acquired by the zoom magnification acquiring unit 905 and the distance acquiring unit 906 is output to a change amount acquiring unit (fourth acquiring unit) 907.

The change amount acquiring unit 907 acquires a change amount characteristic for determining change in the object size in the angle of view and outputs the change amount characteristic to a differential characteristic generator (second generator) 908. The differential characteristic generator 908 generates a differential characteristic (differential characteristic data) for changing a characteristic (lens characteristic) applied to the image and outputs the differential characteristic to a characteristic determining unit (determining unit) 909. The characteristic determining unit 909 outputs the changed characteristic to a characteristic applying unit (first generator) 902 based on the differential characteristic and a lens characteristic (optical characteristic data) acquired from an acquiring unit (first acquiring unit) 910. The characteristic applying unit 902 applies the desired characteristic (lens characteristic) to the image data (first image data) that is input through the image acquiring unit 901, and outputs image data (second image data) to which the desired characteristic is applied to an image development unit 903. The image development unit 903 develops the image data to which the lens characteristic is applied, and outputs video data.

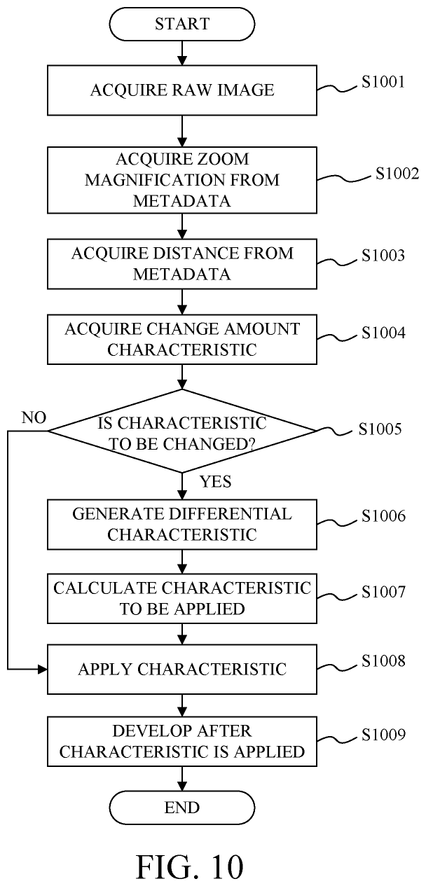

Referring now to FIG. 10, a description will be given of processing (image processing method) by the image processing apparatus 900. FIG. 10 is a flowchart illustrating the processing by the image processing apparatus 900. A description of any processing in FIG. 10 will be omitted as long as it relates to common matters to the first embodiment described above with reference to FIG. 2.

First, at step S1001, the image processing apparatus 900 inputs an image (raw image data, first image data) through the image acquiring unit 901. Next, at step S1002, the zoom magnification acquiring unit 905 acquires zoom magnification at imaging of the image input at step S1001 (zoom magnification during imaging by the image pickup apparatus) from the metadata 904. Next, at step S1003, the distance acquiring unit 906 acquires the distance between the image pickup apparatus and an object at imaging of the image input at step S1001. Next, at step S1004, the change amount acquiring unit 907 calculates (acquires) a change amount characteristic by using the zoom magnification and the distance that are acquired at steps S1002 and S1003, respectively.

Next, at step S1005, the change amount acquiring unit 907 determines whether to change an applied characteristic based on the change amount characteristic acquired at step S1004. In a case where it is determined that the characteristic is to be changed at step S1005, the flow proceeds to step S1006. In a case where it is determined that the characteristic is not to be changed, the flow proceeds to step S1008.

At step S1006, the differential characteristic generator 908 generates, based on the change amount characteristic acquired at step S1004, a differential characteristic (differential characteristic data) for changing a characteristic (aberration characteristic) applied to the raw image data. Next, at step S1007, the characteristic determining unit 909 calculates a characteristic (applied characteristic) to be applied to the raw image data based on the differential characteristic generated at step S1006 and the lens characteristic acquired from the acquiring unit 910. Next, at step S1008, the characteristic applying unit 902 applies the characteristic to the raw image data (first image data), thereby generating raw image data (second image data) to which the characteristic is applied. Finally, at step S1009, the image development unit 903 develops the raw image data to which the characteristic is applied, thereby generating an image signal to be used for recording or outputting.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

According to the present disclosure, it is possible to provide an image processing apparatus capable of acquiring an image to which an appropriate characteristic is applied with a small calculation amount.

This application claims the benefit of Japanese Patent Application No. 2023-031394, which was filed on Mar. 1, 2023, and which is hereby incorporated by reference herein in its entirety.

What is claimed is:

1. An image processing apparatus comprising:
a memory storing instructions; and
a processor configured to execute the instructions to:
acquire optical characteristic data of an optical system,
acquire information about zoom magnification,
acquire information about a distance to an object,
acquire a change amount of at least one of the zoom magnification and the distance based on at least one of the information about the zoom magnification and the information about the distance,
determine a characteristic to be applied to first image data based on the change amount and the optical characteristic data, and
generate second image data by applying the characteristic to the first image data.

2. The image processing apparatus according to claim 1, wherein the optical characteristic data is a parameter for reproducing an aberration characteristic of the optical system by signal processing.

3. The image processing apparatus according to claim 1, wherein the processor is configured to:
generate differential characteristic data about the optical system based on the change amount, and
determine the characteristic to be applied to the first image data based on the differential characteristic data and the optical characteristic data.

4. The image processing apparatus according to claim 3, wherein the processor is configured to generate a difference for changing a first characteristic to a second characteristic based on the change amount.

5. The image processing apparatus according to claim 4, wherein the processor is configured to determine the second characteristic based on the difference.

6. The image processing apparatus according to claim 1, wherein the zoom magnification is zoom magnification for at least one of optical zoom control and electronic zoom control.

7. The image processing apparatus according to claim 1, wherein the processor is configured to acquire the information about the distance using a laser sensor, an ultrasonic sensor, an infrared sensor, or a phase difference sensor.

8. The image processing apparatus according to claim 1, wherein in a case where a plurality of objects exist in an angle of view, the processor is configured to acquire the information about the distance to one object selected from among the plurality of objects.

9. The image processing apparatus according to claim 1, wherein the change amount is a change in a size of an object in an angle of view, which is determined based on a relationship between a change in the zoom magnification and a change in the distance.

10. The image processing apparatus according to claim 1, wherein the processor is configured to:
determine the characteristic so that aberration becomes stronger in a case where it is determined based on the change amount that the object changes to become larger in the angle of view, and
determine the characteristic so that aberration becomes weaker in a case where it is determined based on the change amount that the object changes to become smaller in the angle of view.

11. The image processing apparatus according to claim 1, wherein the processor is configured to:
determine the characteristic as a third characteristic so that aberration becomes stronger in any one of a case where a change has occurred by a first change amount so that the zoom magnification becomes larger and a case where a change has occurred by a second change amount so that the distance becomes shorter, and
determine a fourth characteristic so that the aberration becomes stronger than that with the third characteristic in a case where the zoom magnification has changed by the first change amount and the distance has changed by the second change amount.

12. The image processing apparatus according to claim 1, wherein the processor is configured to:
determine the characteristic to be a fifth characteristic so that aberration becomes weaker in any one of a case where a change has occurred by a third change amount so that the zoom magnification becomes smaller and a case where a change has occurred by a fourth change amount so that the distance becomes longer, and
determine a sixth characteristic so that the aberration becomes weaker than with the fifth characteristic in a case where the zoom magnification has changed by the third change amount and the distance has changed by the fourth change amount.

13. The image processing apparatus according to claim 1, wherein the processor does not change the characteristic in a case where it is determined that a change amount of a size of the object in the angle of view, which is determined based on a relationship between the change amount of the zoom magnification and the change amount of the distance falls within a predetermined range.

14. The image processing apparatus according to claim 1, wherein the processor is configured to acquire the information about the zoom magnification from metadata.

15. The image processing apparatus according to claim 1, wherein the processor is configured to acquire the information about the distance from metadata.

16. An image pickup apparatus comprising:
the image processing apparatus according to claim 1; and
an image sensor configured to output the first image data.

17. An image processing method comprising the steps of:
acquiring optical characteristic data of an optical system;
acquiring information about zoom magnification;
acquiring information about a distance to an object;
acquiring a change amount of at least one of the zoom magnification and the distance based on at least one of the information about the zoom magnification and the information about the distance;
determining a characteristic to be applied to first image data based on the change amount and the optical characteristic data; and
generating second image data by applying the characteristic to the first image data.

18. A non-transitory computer-readable storage medium storing a computer program that causes a computer to execute the image processing method according to claim 17.
